(19) United States
(12) Patent Application Publication
(10) Pub. No.: US 2010/0153430 A1
(43) Pub. Date: Jun. 17, 2010

(54) Method of and Apparatus for Extraction and Analysis of Macro Operations within Query Language Statement

(75) Inventors: Vladimir Mordvinov, Nepean (CA); Soufiane Azizi, Ottawa (CA); Nigel Anthony Campbell, Ottawa (CA)

Correspondence Address: Walder Intellectual Property Law PC, 17330 Preston Road, Suite 100B, Dallas, TX, 75252, US

(73) Assignee: INTERNATIONAL BUSINESS MACHINES CORPORATION, New York, NY (US)

(21) Appl. No.: 12/332,871

(22) Filed: Dec. 11, 2008

(51) Int. Cl. G06F 17/30

(52) U.S. Cl. 707/769; 707/E17.015

(57) ABSTRACT

A method receives a query containing at least a statement, and analyzes the statement to determine a query structure of elements forming the statement. The text of the statement is formatted to reflect the query structure. The formatted text is replaced with an equivalent tree of logical blocs representing the statement in a higher level. The representation of one or more of the logical blocks is shortened. A data flow tree of macro operation nodes is generated based on the logical blocks for presentation to a user.

### FIELD OF THE INVENTION

The present invention relates to a method of and apparatus for processing query representation, and particularly to a method of and apparatus for extraction and analysis of macro operations within query language statement

### BACKGROUND OF THE INVENTION

There exist various Business Intelligence (BI) tools that allow users to analyze business oriented data stored in one or more underlying data sources. Users ask business questions through a reporting tool, which generates a BI query against the underlying data source.

BI Queries responding to user's business questions, in majority of cases, lead to very complex Structured Query Language (SQL) or Multi Dimensional Expression (MDX) queries depending on the data source against which the query is executed.

Even though the SQL and MDX is not expected to be understood by users, there are quite a few scenarios when the SQL and MDX must be analyzed, the work that can be done by Information Technology (IT) personnel supporting the BI tools: for example, performance optimization of queries and databases, unexpected query results, and data access auditing to extract the database use patterns.

While definition of the BI Query semantics is theoretically enough to predict the outcome of BI Queries, when a performance or logical issue arises, the BI Server or a database administrator needs to analyze native SQL and MDX queries generated by the system, as it is the main factual evidence expresses in a independently documented language.

The challenges that SQL and MDX analysis poses include: large SQL and MDX statements require some top down analysis techniques, locating an error in SQL and MDX statements, analysis of the relationships of the SQL/MDX generated in a Query Engine system with the rest of Execution plan (Run Tree), profiling the efficiency of SQL and MDX statements blocks. Tools are needed to help in understanding the various blocks and components in these SQL/MDX statements.

Modern database systems are equipped with the tools simplifying the analyses of the SQL/MDX statements. However, generation of a high level view of SQL statements has been limited to the extraction of joining structure of the outmost select query.

Therefore, there is a need to provide a mechanism that can provide better representation of the SQL/MDX statements.

### SUMMARY OF THE INVENTION

It is an object of the invention to provide an improved method of and apparatus for processing query representation that obviates or mitigates at least one of the disadvantages of existing systems.

The invention extracts and analyzes macro operations within a query language statement.

In accordance with an aspect of the present invention, there is provided a method of processing query representation comprising receiving a query to analyze, the query containing at least a statement; analyzing the statement to determine a query structure of elements forming the statement; formatting text of the statement to reflect the query structure; replacing the formatted text with an equivalent tree of logical blocs representing the statement in a higher level; shortening the representation of one or more of the logical blocks; and generating a data flow tree of macro operation nodes based on the logical blocks for presentation to a user.

In accordance with another aspect of the present invention, there is provided a query representation processing system comprising a query statement structure analyzer, a statement text format manager, a logical blocks representation manager and a tree representation manager. The query statement structure analyzer is provided for receiving a query and analyzing statements in the query to determine a query structure of elements forming the statement. The statement text format manager is provided for formatting text of the statement to reflect the query structure, and replacing the formatted statement text with an equivalent statement that visually expresses logical blocs comprising the statement in a higher level. The logical blocks representation manager is provided for shortening the representation of one or more of the logical blocks based on abbreviation rules. The tree representation manager is provided generating a data flow tree of macro operation nodes based on the logical blocks for presentation to the user.

In accordance with another aspect of the present invention, there is provided a computer program product for processing query representation, the computer program product comprising a computer usable medium having computer usable program code embodied therewith. The computer usable program code comprises computer usable program code configured to perform a method comprising receiving a query to analyze, the query containing at least a statement; analyzing the statement to determine a query structure of elements forming the statement; formatting text of the statement to reflect the query structure; replacing the formatted text with an equivalent tree of logical blocs representing the statement in a higher level; shortening the representation of one or more of the logical blocks; and generating a data flow tree of macro operation nodes based on the logical blocks for presentation to a user.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 is a block diagram showing a query representation processing system in accordance with an embodiment of the invention;

FIG. 2 is a flowchart showing a method of processing query representation in accordance with an embodiment of the invention;

FIG. 3 is a flowchart showing an example of a top-down analysis of an SQL query statement;

FIG. 4 is a flowchart showing an example of a top-down analysis of an MDX query statement;

FIG. 5 is a diagram showing an example of a tree of blocks of a query statement;

FIG. 6 is a diagram showing another example of a tree of blocks of a query statement;

FIG. 7 is a diagram showing another example of a tree of blocks of a query statement;

FIG. 8 is a diagram showing another example of a tree of blocks of a query statement;

FIG. 9 is a diagram showing another example of a tree of blocks of a query statement;

FIG. 10 is a diagram showing another example of a tree of blocks of a query statement;

FIG. 11 is a diagram showing another example of a tree of blocks of a query statement;

FIG. 12 is a diagram showing a tree of visualization logical blocks representing a query statement;

FIG. 13 is a block diagram showing an embodiment of the query representation processing system;

FIG. 14 is a block diagram showing an embodiment of a query statement structure analyzer;

FIG. 15 is a block diagram showing an embodiment of a statement text format manager; and

FIG. 16 is a block diagram showing an embodiment of a visualization rules manager.

### DETAILED DESCRIPTION OF PREFERRED EMBODIMENTS

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

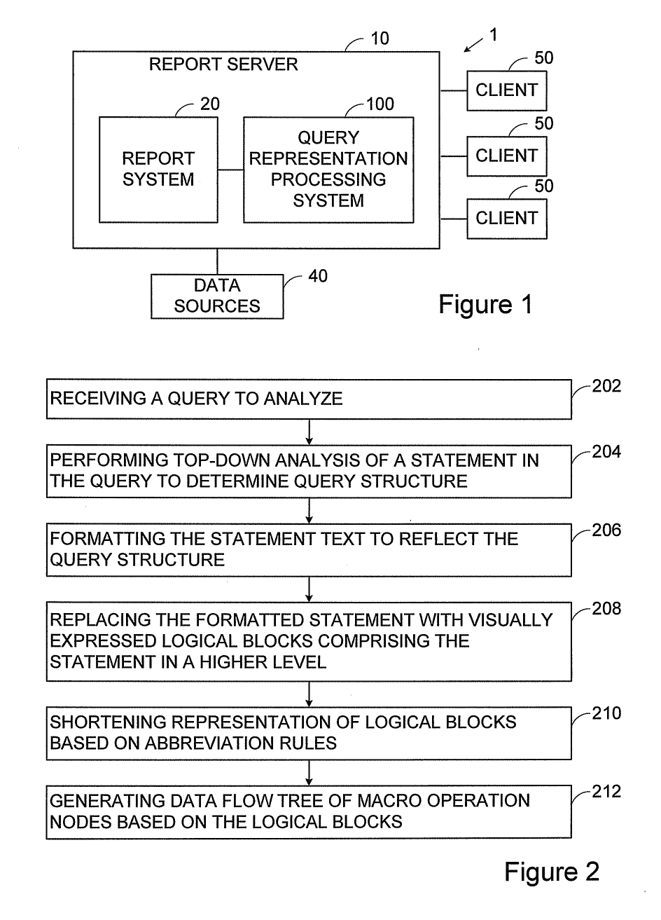

Referring now to FIG. 1, a query representation processing system 100 in accordance with an embodiment of the application is described. The query representation processing system 100 can be suitably used in a computer system 1 in or with a report server 20 that receives user's questions or requests for data, generates queries based on the questions, process and executes the queries to generate reports of data in one or more underlying data sources 40. These systems may be suitably used in server-client environments as exemplified with report server 10 and clients 50.

The query representation processing system 100 receives the queries generated by the report system 20, and processes the queries to generate visual high level representations of the queries that visually represent significant operations, i.e., macro operations, within query languages statements. The high level representation of query language statements can open the macro operations up for external component access.

FIG. 2 shows a flow chart showing an embodiment of the method carried out by the query representation processing system 100. The query representation processing system 100 receives a query to analyze (202). The query contains one or more statements. The query representation processing system 100 performs a top-down analysis of the statements to determine the query structure, i.e., the structure of elements or blocks forming the statement (204). A statement is broken down into a hierarchy of blocks or elements, representing significant elements of the statement. The query representation processing system 100 formats the text of the statement to reflect the query structure determined by the top-down analysis (206). The query representation processing system 100 replaces the formatted statement text with an equivalent statement that visually expresses logical blocs comprising the statement in a higher level (208). The query representation processing system 100 shortens the representation of one or more of the logical blocks based on abbreviation rules (210). Then, the query representation processing system 100 generates a data flow tree of macro operation nodes based on the logical blocks for presentation to the user (212).

The method shown in FIG. 2 is further described for processing SQL and MDX queries.

The top down analysis 204 of SQL/MDX statements breaks a statement into a hierarchy of blocks or elements, representing significant elements of the statement.

The significant logical elements that are recognized in SQL statements include (1) Table operation blocks, (2) Select blocks, and (3) collections of elements. A Table operation block (1) may include Select blocks; Joins; Table set operations, such as, UNION, INTERSECT, and EXCEPT; and/or References to database Tables, Views, and Table Functions. A Select block (2) in turn can be broken into the fragments, such as “Projection” item expressions, following the starting Select statement keywords; “From clause” block, referencing one or join/cross-product of several tables; “With block”, a collection of derived tables used in multiple contexts; “Where clause”, expressing pre-grouping filtering; “Having clause”, expressing post-grouping filtering; “Group-by clause”; “Order-by clause”; and/or “Request options” block, dialect specific, containing options like Fetch First. The collection of elements (3) includes “Projection”, “With block”, “Group-by clause”, and “Order-by clause” Elements of these collections can also be recognized significant components of the statement structure.

The significant logical elements that are recognized in MDX statements include (1) Select statement; and (2) collections of elements. A Select statement (1) can be broken into the fragments, such as “With block”, a collection of calculated members and named sets definitions; “Axis expressions”, following the starting Select statement keywords; “From clause” block, referencing a cube; and/or “Where clause” expressing a slicer. The collections of elements (2) include “With block”, and “Axis expressions”. Elements of these collections can also be recognized significant components of the statement structure.

The groups of the significant logical elements are described above from the large scope to lower scope structural elements. They are treated as levels of the top-down analysis of the SQL/MDX statements.

While exact syntax of expressions used in different statement parts vary, all expressions in SQL and MDX statements bear the main components including Literals; Brackets that play the role of operation grouping; Unary operators; Binary operators; Operators involving more than two parameters; and Functions. There are more complex syntactical constructs, such as the CASE operator in SQL.

From the point of view of top-down visual analysis of the expressions, it is also noted that the associative binary operations may form clusters of operations that do not change their meaning depending of the sequence of the operator evaluation. The important operators of this type are: “AND”, “OR” and “+”. For example, “AND” in (T1.A=T2.A) AND (T1.B=T2.B) AND (T1.C=T2.C) is this type of operators.

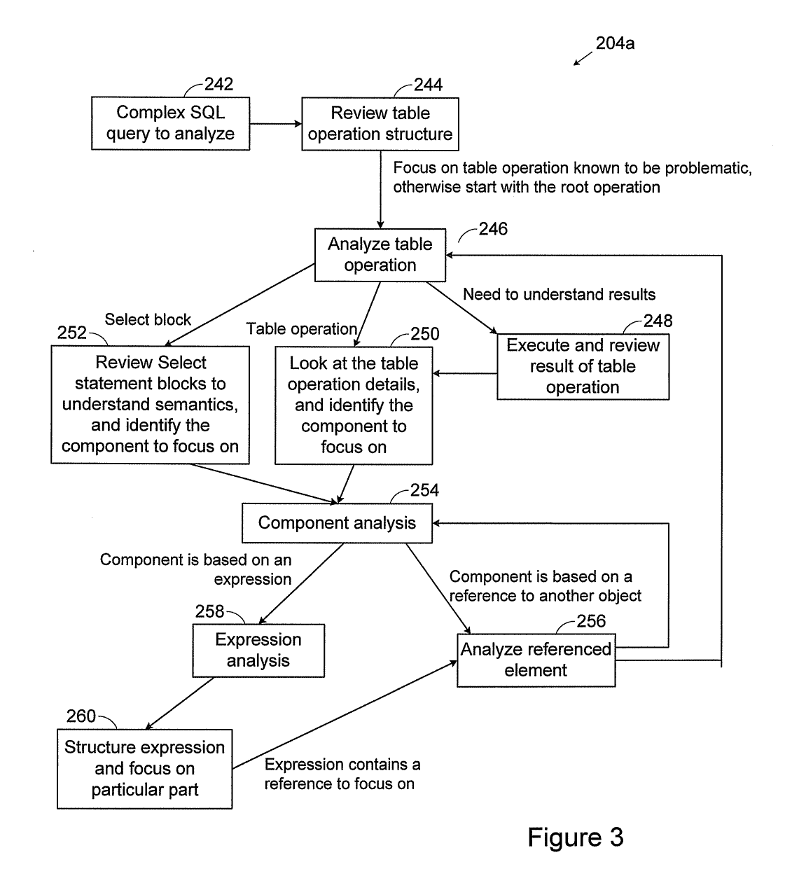

FIG. 3 shows an embodiment of the top-down analysis 204a of a SQL statement. For a complex SQL query 242 to be analyzed, a structure of table operations in the SQL statement is reviewed (244). If a certain table operation is known to be problematic ahead of time, this table operation is analyzed (246). Otherwise, the analysis starts with the root operation of the table operations in the SQL statement. When the analysis of a table operation needs to understand results of the table operation, the table operation is executed and the results of the execution are reviewed (248). For each table operation (246), after execution and review of the table operation (248) as necessary, the table operation details are reviewed to identify one or more components of the table operation definition on which the analysis is to be focused further (250). Typically, reviewing the result of a given table operation helps an SQL/MDX author to identify a specific problem with the result. For example, if a join result renders more rows than necessary, the join condition needs to be analyzed. Select statement blocks are reviewed to understand their semantics, and based on the semantics, to identify one or more components in the Select statement blocks on which the analysis should be focused (252). The identified component are analyzed further (254). For a component that is based on a reference to another element, the referenced element is analyzed (256) to analyze components in the definition of the referenced element (254). If the referenced element is a table operation, the process goes back to the table operation analyzing step (246). If a component is based on an expression, the expression is analyzed (258) by structuring the expression to reflect the sequence of operations (260). In order to be able to focus on a particular part of the expression, the expression may need to be broken into multiple sub-expressions to see the result of an individual piece, or as in the case the filtering expression to see the impact of the sub-expression on tabular block result. For the sub-expressions based on a reference to a different component, the focus of the analysis may further be shifted to the reference component (256).

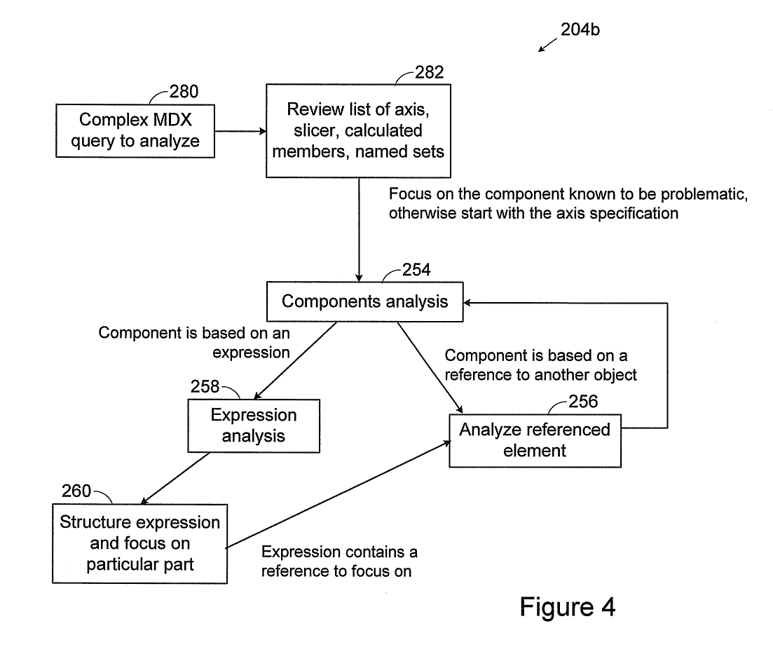

FIG. 4 shows an embodiment of the top-down analysis 204b of an MDX statement. The MDX analysis workflow is simplified version of the SQL workflow shown in FIG. 3. The same reference numerals are used for similar actions. For a complex MDX query 280 to be analyzed, a list of axis, slicer, calculated members and named sets in the MDX statement are reviewed (282). If one of these components is known to be problematic ahead of time, analysis is started with that component. Otherwise, the analysis starts with the axis expressions (254). The remaining actions are similar to those shown in FIG. 3, except that-the referenced element is not a table operation in the MDX statement.

The above top-down analysis determines the query structure of the SQL/MDX statement. This query structure of the SQL/MDX statement is used to format the SQL/MDX structure text (280 in FIG. 2), and replace it with an equivalent statement that visually expresses logical blocks comprising the statement (280 in FIG. 2).

The text formatting is done according to formatting rules, by inserting spaces and line breaks in a language string, given these symbols are largely ignored by syntax rules, apart from being separators between language tokens. Thus, the SQL/MDX statement is broken into a tree of structural blocks described above.

In the text formatting approach, child blocks are padded with spaces or tab characters to appear shifted to the right versus there parent blocks. A first child may be put on the same line as parent block. Sibling blocks are placed on new lines with the same padding space. Alternatively, the XML or HTML tags can be inserted into the text to identify the beginning and the end of every block. HTML formatting rules may then be applied to make the child blocks to be shifted to the left from the left boundaries of the parent blocks.

For example, the following demonstrates how these formatting rules work in the case of the UNION combining two Select blocks:

SELECT T1.B1, sum(T1.B2) FROM T1 GROUP BY T1.B1 UNION
(SELECT T1.B1,T1.B2 FROM T1)

Assuming a level padding on the left is based on two spaces: the above statement is formatted as follows:

```
    SELECT T1.B1, sum(T1.B2)
    FROM T1
    GROUP BY T1.B1
UNION
  (
    SELECT T2.A1, 1
    FROM T2
  )
```

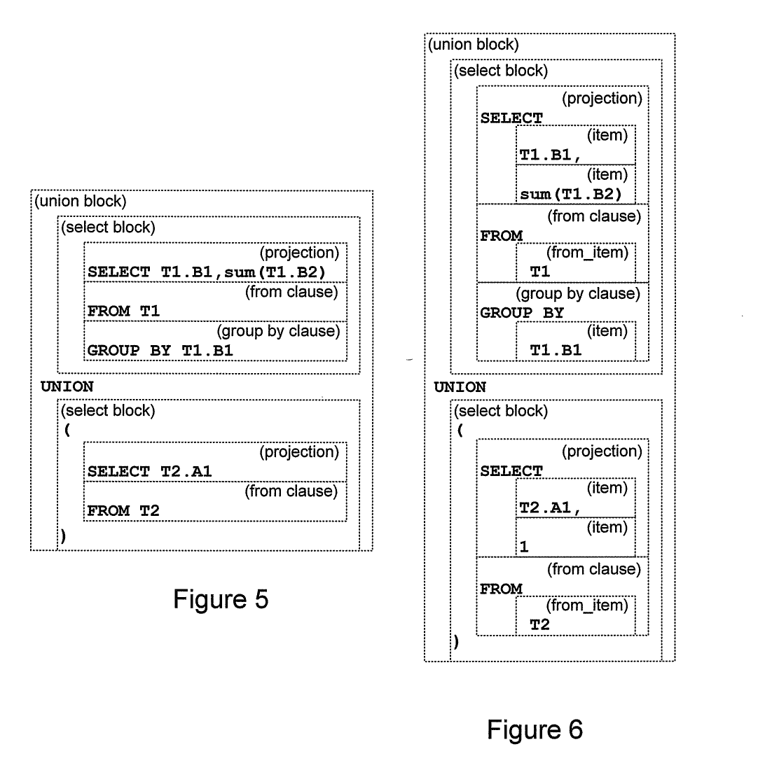

The structure of this presentation can be thought of in the form of hierarchy of blocks, as shown in FIG. 5. The hierarchy includes a union block and two select blocks. The first select block includes a projection block, a from clause block and as group by clause block. The second select block includes a projection block and a from clause block.

The formatting process transitions this presentation to more detail presentation. The diagram shown in FIG. 6 formats the query structure up to the level of select block details. Items or components of the “Select”, “From” and “Group-by” blocks, can also be formatted as individual element, visualizing further level details. This can be thought of as a transition to more detail presentation as now every item is visualized as an individual element.

For example, the original query looks as follows after transitioning to the lower level of details:

```
SELECT
    T1.B1,
    sum(T1.B2)
FROM
    T1
GROUP BY
    T1.B1
UNION
  (
    SELECT
        T2.A1,
        1
    FROM T2
  )
```

In the block form, this detail presentation can be seen as the structure shown in FIG. 6. For example, the projection block of the first select block shown in FIG. 5 is now transitioned to show two item blocks.

The formatting process further transitions the detail presentation to a higher level view. Using the example of the original query formatted up to the sections of select statements shown in FIG. 6, the following representation corresponds to a higher level view:

```
    SELECT T1.B1, sum(T1.B2) FROM T1 GROUP BY T1.B1
UNION
  ( SELECT T2.A1, 1 FROM T2 )
```

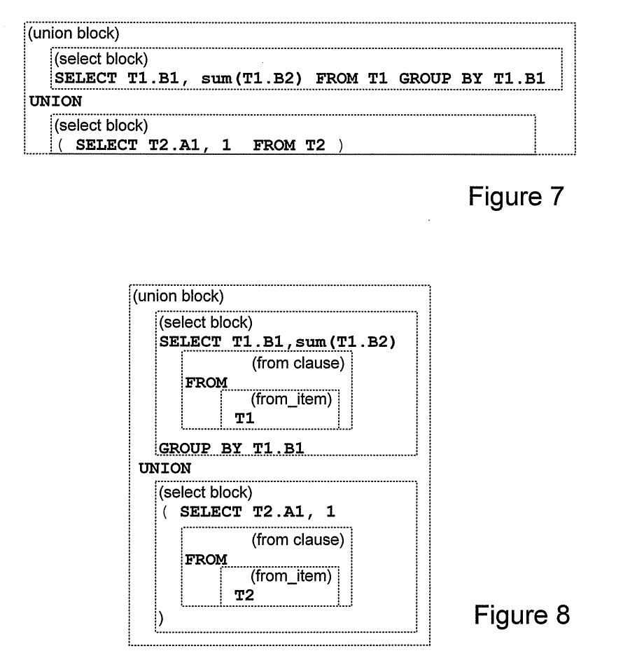

In terms of the structure, this represents the SQL statement as a tree of table operations, as shown in FIG. 7, assuming that a reference to tables is not recognized as an independent table operation:

The view of the block structure shown in FIG. 7 significantly changes when a reference to tables is to be associated with a block, as the content of the from clause has to be fully formatted, as follows:

```
    SELECT T1.B1,sum(T1.B2)
    FROM
        T1
    GROUP BY T1.B1
UNION
  (
    SELECT T2.A1, 1
    FROM
    T2
  )
```

In this case, the block structure is also significantly different as shown in FIG. 8.

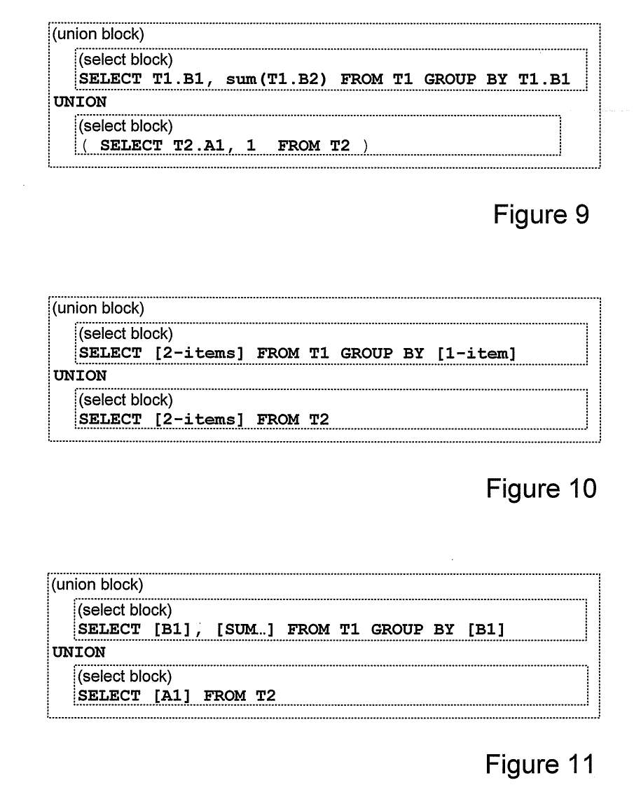

Associating larger structural parts with visualization logical blocks can be used in order to provide a higher level view, as described above and shown in FIG. 9.

However, those logical blocks identified in this process may be populated by a very long multi-line string, which may lose the value of the higher level view of the SQL statement. In that case, the block representation shortening process (210 in FIG. 2) shortens the text representation of the logical blocks (210 in FIG. 2). The shortening process uses abbreviation rules that allow showing only part of the string in a given block, but still provide a good idea what this block is.

For example, the query representation shown in FIG. 9 can be shortened to that shown in FIG. 10, where item lists are replaced with the block showing how many items are in this block.

FIG. 11 shows another example where further level of details for items are shown by a shortened version of the items.

Another example to further demonstrate simplification of the representation is provided for the following SQL statement:

```
select (EXTRACT( YEAR FROM
  (“ORDER_HEADER”.“ORDER_DATE”)
  )*10000+EXTRACT( MONTH FROM
  (“ORDER_HEADER”.“ORDER_DATE”)
  )*100)+EXTRACT( DAY FROM
  (“ORDER_HEADER”.“ORDER_DATE”) )
  “Day_key_order_date_”,
  “ORDER_DETAILS”.“QUANTITY” “Quantity”
from “ORDER_DETAILS” “ORDER_DETAILS”,
“ORDER_HEADER” “ORDER_HEADER”
where
“ORDER_HEADER”.“ORDER_NUMBER”=
“ORDER_DETAILS”.“ORDER_NUMBER”)
```

A shortened version of this SQL statement is:

select [2 items]
from [ORDER_DETAILS], [ORDER_HEADER]
where [...]
or
select [Day_key_order_date], [Quantity]
from [ORDER_DETAILS], [ORDER_HEADER]
where [...]

The abbreviation rules for block text representation used in the shortening process are now described. A logical block has four states in respect to its text representation: (1) closed; (2) open abbreviated, children closed; (3) open, children in abbreviated state; and (4) open, children open.

The abbreviated form is enclosed in square brackets: [ ]. The abbreviated form of block text representation is defined per block type. The abbreviated form can be either based on a substring of the text that belongs to this block, excluding the text of its children, as follows:

Expressions have no abbreviation;

SQL Projection items are abbreviated by their aliases;

SQL From-items are abbreviated by their aliases;

SQL Select blocks are abbreviated by the keywords with which the blocks start;

SQL Derived table aliases are abbreviated by their alias;

MDX Calculated member are abbreviated by their names;

MDX Named sets are abbreviated by their names; and

MDX axis are abbreviated by the axis identifier.

If no text is chosen for the abbreviation and its children are in a closed state, the ellipsis symbol “ . . . ” is used under the brackets.

The visualization rules, including the formatting rules used during the statement text formatting process and/or the abbreviation rules used during the block representation shortening process, may be declared.

The declaration of visualization rules is now described for the embodiments that use Backus-Naur Form (BNF). The structure of SQL/MDX concepts can be aligned with the syntactic elements of these languages. For example, the following trimmed BNF is considered for a sample dialect of SQL syntax:

```
  <SQL query> ::= [ <with clause> ] <query expression > [ <order by clause> ]
[<request options>]
  <with clause> ::= WITH <with list>
  <with list> ::= <with list element> [ { <comma> <with list element> }... ]
  <with list element> ::=
      <query name> [ <left paren> <with column list> <right paren> ]
      AS <left paren> <query expression> <right paren>
<query expression> ::=
      <query term>
    | <query expression> <query expression type> <query term>
<query expression type> ::=
    UNION [ ALL | DISTINCT ]
    | EXCEPT [ ALL | DISTINCT ]
    | INTERSEPT [ ALL | DISTINCT ]
<query term> ::= <select specification> | <left paren> <query expression> <right
paren>
  <select specification> ::=
    SELECT [ <set quantifier> ] <select list>
      <from clause> [ <where clause> ] [ <group by clause> ] [ <having clause> ] [
<window clause> ]
<from clause> ::= FROM <table reference list>
<table reference list> ::= <table reference> [ { <comma> <table reference> }... ]
<table reference> ::= <table primary or joined table> [ <sample clause> ]
<table primary or joined table> ::= <table primary> | <joined table>
<joined table> ::=
      <table reference> <join type> <table primary>
    |  <table reference> <join type2> <table reference> <join specification>
<join type> ::=
      CROSS JOIN
      | INNER JOIN
    | <outer join type> [ OUTER ] JOIN
    | NATURAL [ <join type> ] JOIN
    | UNION JOIN
<join type2> ::=
    | INNER JOIN
    | <outer join type> [ OUTER ] JOIN
    | NATURAL [ <join type> ] JOIN
<outer join type> ::= LEFT | RIGHT | FULL
<table primary> ::=
        <table name> [ [ AS ] <correlation name> [ <left paren> <derived column list>
<right paren> ] ]
        <query name> [ [ AS ] <correlation name> [ <left paren> <derived column list>
<right paren> ] ]
    | <left paren> <query expression> <right paren> [ AS ] <correlation name>
      [ <left paren> <derived column list> <right paren> ]
    | <left paren> <joined table> <right paren>
<table name> ::=
```

The significant blocks of a SQL statement identified above can be associated with the elements of the BNF, as shown in Table 1.

TABLE 1

| SQL visualization fragments | BNF element |
|---|---|
| Select blocks | <select |
| | specification> |
| Joins | <joined table> |
| Table set operations: UNION, INTERSECT, | <query expression> |
| EXCEPT | |
| References to database Tables, Views, Table | <table or query |
| Functions | name> |
| “Projection” item expressions, following the starting | <select list> |
| Select statement keywords. | |
| “From clause” block, referencing one or join/cross- | <from clause> |
| product of several tables. | |
| “With block”, a collection of derived tables used in | <with clause> |
| multiple contexts | |
| “Where clause”, expressing pre-grouping filtering | <where clause> |
| “Having clause”, expressing post-grouping filtering | <having clause> |
| “Group-by clause” | <group by clause> |
| “Order-by clause” | <order by clause> |
| “Request options” block, dialect specific, containing | <request options> |
| options like Fetch First. | |

Hence, the BNF rules can be extended to mark those syntactical elements in the BNF notation. The BNF notations are associated with visualization blocks as follows.

The formatting rules may be defined as extension of syntax rules. Extending description of BNF elements with formatting instructions can drive the visualization of the corresponding query language.

There are two properties that drive language formatting: (1) a flag marking a syntactical element to be associated with a formatting block, and (2) parts of the element to be used for its abbreviation. These properties can be incorporated into BNF notion, for example, using the method below:

```
<select specification> ::= SELECT [ <set quantifier> ] <select list>
      <from clause> [ <where clause> ] [ <group by clause> ] [
      <having clause> ] [
<window clause> ]
<select specification>.format ::= block
<select specification>.abbreviation ::= SELECT <set quantifier>
<query expression> ::=
    <query term>
  | <query expression> <query expression type> <query term>
<query expression type> ::=
    UNION [ ALL | DISTINCT ]
  | EXCEPT [ ALL | DISTINCT ]
  | INTERSEPT [ ALL | DISTINCT ]
<query expression>.format ::= block
<query expression>.abbreviation ::= <query expression type>
```

Alternatively, a separate table can be used, listing all syntax elements formatted as blocks with their abbreviation rules and syntax element that are not formatted individually but have also an non-trivial abbreviation rule. Table 2 shows an example of such a table listing the syntax elements.

TABLE 2

| Syntax element | Format | Abbreviation |
|---|---|---|
| <select specification> | Block | SELECT <set quantifier> |
| <query expression> | Block | <query expression type> |
| <joined table> | Block | <join type> \| <join type2> |
| <table primary> | Block | <correlation name> \| <table name> \| |
| | | <query name> |

The interpretation of the abbreviation rule is as follows. The abbreviation rule lists components comprising the shortened form of the element in a sequence that they appear in the result string. The components of abbreviation base on references to syntax elements imply that the abbreviated form of the referenced element is to be used. For elements that do not have an explicitly defined abbreviated form, it is implied that the whole string is to be used. The results of the abbreviation rules may be stored temporarily in memory while they are being generated, and then in the end combined into the overall view of the shortened query representation.

The options (separated by the symbol ‘|’) in the abbreviation rules are checked in a sequence. If the first option rendered an empty string, then the second one is checked, and so on.

As an abbreviation rule references child syntax elements, there should be only one reference to a given type of syntax element used in an abbreviation rule in order to make the reference unambiguous. If an abbreviation rule happens to reference another element few times, this abbreviation rule needs to be disambiguated. For example, the abbreviation rule:

A.abbreviation ::=B

for the element defined as:

A ::=B AND B

Is ambiguously defined. The ambiguity of the abbreviation rule can be fixed by replacing the element definition as:

A ::=B AND B2

B2 ::=B

The process of generating the tree representation of a statement (214 in FIG. 2) is now described further. The SQL and MDX logic can be thought of as a data flow tree comprised by macro operation nodes that can be executed independently of other parts of the query. Such macro operation tree nodes in an SQL statement are syntax constructs with table type result, such as: Select query/subquery; Table reference; Joins; and/or Table expressions: UNION, EXCEPT, INTERSECT. An MDX statement is less suitable for this approach, but the following elements can be recognized as tree nodes: Named sets; Edge expressions; and/or Overall Select statement.

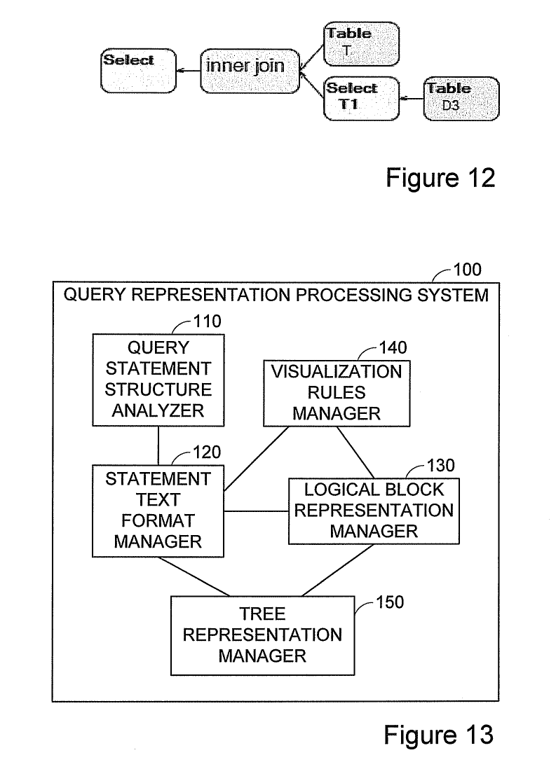

The tree representation is comprised by the tree nodes with titles and body content pre-defined based on the logical blocks of the statement, as exemplified in FIG. 12. Which elements ought to be included into the tree representation and the content of node title and body can be defined as an extension of the syntax element formatting rules, as exemplified in Table 3.

TABLE 3

| | | | | | Tree |
|---|---|---|---|---|---|
| Syntax | | Ab- | Tree | | node |
| element | Format | breviation | node | Tree node title | body |
| <select | . . . | . . . | True | Select | |
| specification> | | | | | |
| <query | | | True | <query expression | |
| expression> | | | | type> | |
| <joined table> | | | True | <join type>\|<join | |
| | | | | type2> | |
| <table | | | True | Table | <table |
| primary> | | | | <correlation | name> \| |
| | | | | name> | <query |
| | | | | | name> |

As tree nodes are logically independent of parent nodes, they can be analyzed separately. For example, the tree nodes can be executed to show results. Also, the tree nodes can be profiled to capture their performance, though the performance of these nodes is not always independent of their parent node context as, for example, parent node filtering can be passed down to their children nodes. Still independent profiling of tree nodes can identify those nodes that contain inefficient function/operations.

FIG. 13 shows an embodiment of the query representation processing system 100. The query representation processing system 100 comprises a query statement structure analyzer 110, statement text format manager 120, logical block representation manager 130, visualization rules manager 140 and tree representation manager 150.

The query statement structure analyzer 110 receives a query and analyzes statements in the query to determine the query structure of elements or blocks forming the statement. The statement text format manager 120 formats the text of the statement based on formatting rules to reflect the query structure, and replaces the formatted statement text with an equivalent statement that visually expresses logical blocs comprising the statement in a higher level. The logical block representation manager 130 shortens the representation of one or more of the logical blocks based on abbreviation rules. The visualization rules manager 140 manages declaration of visualization rules including the formatting rulers and abbreviation rules. The tree representation manager 150 generates a data flow tree of macro operation nodes based on the logical blocks for presentation to the user.

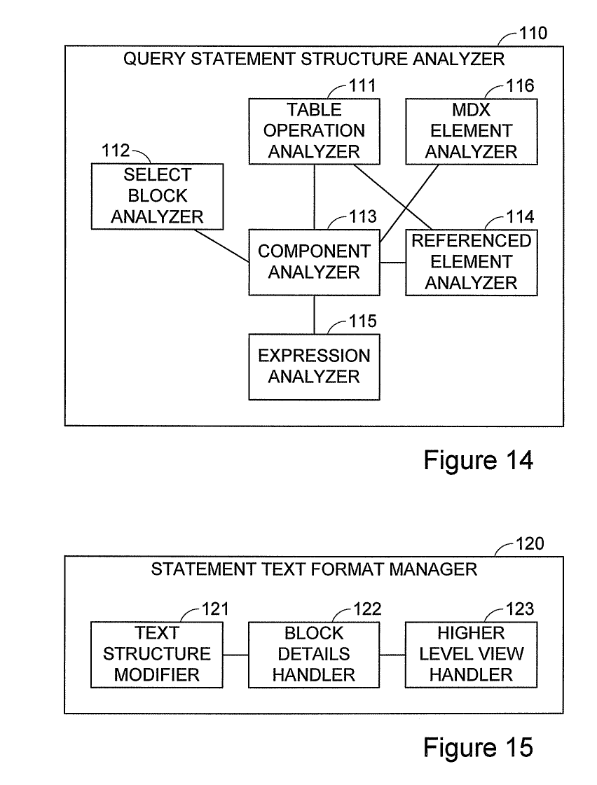

FIG. 14 shows an embodiment of the query statement structure analyzer 110. The query statement structure analyzer 110 in this embodiment comprises a table operation analyzer 111, select block analyzer 112, component analyzer 113, referenced element analyzer 114, expression analyzer 115 and MDX element analyzer 116.

The table operation analyzer 111 analyzes table operations in SQL statements to identify select blocks and other components of the table operation definition for which further analysis should be made. The table operation analyzer 111 executes a table operation when the analysis of the table operation needs to understand results of the table operation. The select block analyzer 112 reviews select statement blocks to understand their semantics and identify components in the select statement blocks on which the analysis should be focused.

The component analyzer 113 analyzes the identified components to identify a component that is based on an expression. The referenced element analyzer 114 analyzes referenced elements for a component that is based on a reference to another element. The expression analyzer 115 analyzes the expression by structuring the expression to reflect the sequence of operations. The expression analyzer 115 may break the expression into multiple sub-expressions to focus on a particular part of the expression.

The MDX element analyzer 116 analyzes a list of axis, slicer, calculated members and named sets in the MDX statements to identify components for which further analysis should be made.

The query statement structure analyzer 110 uses the table operation analyzer 111, select block analyzer 112, component analyzer 113, referenced element analyzer 114 and expression analyzer 115 to perform the top-down analysis of a SQL statement, as described above referring to FIG. 2.

The query statement structure analyzer 110 uses the MDX element analyzer 116, component analyzer 113, referenced element analyzer 114 and expression analyzer 115 to perform the top-down analysis of a MDX statement, as described above referring to FIG. 3.

FIG. 15 shows an embodiment of the statement text format manager 120. In this embodiment, the statement text format manager 120 comprises a text structure modifier 121, block details handler 122 and higher level view handler 123.

The text structure modifier 121 inserts spaces and line breaks in a language string, according to the formatting rules to brake the statement into a tree of structural blocks. The text structure modifier can alternatively insert XML or HTML tags to reflect the beginning and the end of the structural blocks. The block details handler 122 transitions the presentation of the tree of structural blocks to more detail presentation. The higher level view handler 123 transitions the detail presentation to a higher level view represented by a tree of logical blocks.

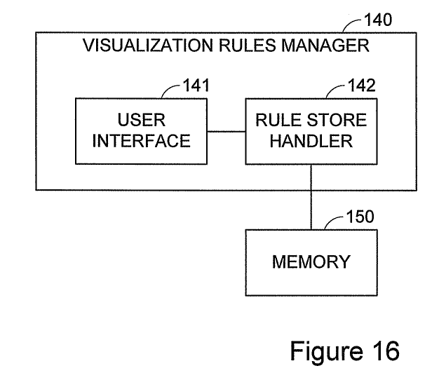

FIG. 16 shows an embodiment of the visualization rules manager 140. The visualization rules manager 140 in this embodiment has a user interface 141 and rule store handler 142. The user interface 141 allows the user to manage declaration of the visualization rules. The rule store handler 142 is coupled with a memory 150 to store the declaration of the visualization rules, and allows the use of the visualization rules by the statement text format manager 120 and logical block representation manager 130.

As described above, the query representation processing system 100 applies a flexible method of macro operation extraction out of SQL/MDX statements. Thus, SQL/MDX statements are decomposed using a general notion of the macro operation providing a flexibility of what is recognized as a macro operation within these statements. The query representation processing system 100 can expose SQL/MDX statement components for interaction with service provides in a query framework system that processes queries using various loosely coupled service providers. This method exposes macro components of the SQL/MDX statements for logging, debugging and profiling functionality developed for the service providers of the query framework system. The query representation processing system 100 makes the operations based on SQL and MDX statements to be more deeply integrated in the query framework system. The query framework system allows for maximum flexibility for query interception, interpretation, and transformation. On the other hand, it facilitates the reuse of the functionality of components already available in the system. The query framework system provides the base for pluggable component architecture; querying multidimensional, relational, and vendor query datasources; data agnostic query service: supporting same operations regardless of a datasource with a consistent plug-in API; and cross-datasource joins.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of processing query representation comprising:
receiving a query to analyze, the query containing at least a statement;
analyzing the statement to determine a query structure of elements forming the statement;
formatting text of the statement to reflect the query structure;
replacing the formatted text with an equivalent tree of logical blocs representing the statement in a higher level;
shortening the representation of one or more of the logical blocks; and
generating a data flow tree of macro operation nodes based on the logical blocks for presentation to a user.

2. The method as claimed in claim 1, wherein the query is a Structured Query Language (SQL) query, and the analyzing the statement performs a top-down analysis of a SQL statement by:
analyzing a structure of table operations in the SQL statement to identify select blocks and table operation details;
analyzing the select blocks and table operation details to identify components to be focused;
analyzing the components to identify a component that is based on an expression; and
analyzing the expression by structuring the expression to reflect a sequence of the table operations.

3. The method as claimed in claim 2, wherein the analyzing the table operations executes a table operation when analysis of the table operation needs to understand results of the table operation.

4. The method as claimed in claim 2, wherein the analyzing the components, for a component that is based on a reference to another element, analyzes the referenced element.

5. The method as claimed in claim 1, wherein the query is a Multi Dimensional Expression (MDX) query, and the analyzing the statement performs a top-down analysis of a MDX statement by:
analyzing a list of axis, slicer, calculated members and/or named sets in the MDX statement to identify components to be focused;
analyzing the components to identify a component that is based on an expression; and
analyzing the expression by structuring the expression to reflect a sequence of the components of the MDX statement.

6. The method as claimed in claim 5, wherein the analyzing the components, for a component that is based on a reference to another element, analyzes the referenced element.

7. The method as claimed in claim 1, wherein formatting text of the statement comprises:
inserting spaces and line breaks or tags identifying each block beginning and ending in a language string of the statement based on formatting rules to brake the statement into a tree of structural blocks;
transitioning presentation of the tree of structural blocks to more detail presentation; and
transitioning the detail presentation to a higher level view represented by a tree of logical blocks.

8. The method as claimed in claim 1, wherein the shortening the representation shortens the representation based on abbreviation rules.

9. The method as claimed in claim 1, further comprising:
managing declaration of visualization rules including formatting rules based on which the text of the statement is formatted and abbreviation rules based on which the representation is shortened.

10. The method as claimed in claim 9, wherein the managing declaration comprises:
allowing management of declaration of the visualization rules by a user;
storing the declaration of the visualization rules in a memory; and
allowing the visualization rules accessed when the text is formatted and the representation is shortened.

11. A query representation processing system comprising:
a query statement structure analyzer receiving a query and analyzing statements in the query to determine a query structure of elements forming the statement;
a statement text format manager formatting text of the statement to reflect the query structure, and replacing the formatted statement text with an equivalent statement that visually expresses logical blocs comprising the statement in a higher level;
a logical blocks representation manager shortening the representation of one or more of the logical blocks based on abbreviation rules; and
a tree representation manager for generating a data flow tree of macro operation nodes based on the logical blocks for presentation to the user.

12. The query representation processing system as claimed in claim 11, wherein the query statement structure analyzer comprises:
a table operation analyzer analyzing table operations in SQL statements to identify select blocks and other components of the table operation definition for which further analysis should be made;
a select block analyzer reviewing select statement blocks to understand their semantics and identify components in the select statement blocks on which the analysis should be focused;
a component analyzer for analyzing the identified components to identify a component that is based on an expression; and
an expression analyzer for analyzing the expression by structuring the expression to reflect the sequence of operations.

13. The query representation processing system as claimed in claim 12, wherein the table operation analyzer is capable of executing a table operation when the analysis of the table operation needs to understand results of the table operation.

14. The query representation processing system as claimed in claim 12, wherein the query statement structure analyzer further comprises:
a referenced element analyzer analyzing referenced elements for a component that is based on a reference to another element;

15. The query representation processing system as claimed in claim 11, wherein the query statement structure analyzer comprises:
an MDX element analyzer analyzing a list of axis, slicer, calculated members and named sets in the MDX statements to identify components for which further analysis should be made;
a component analyzer analyzing the identified components to identify a component that is based on an expression; and
an expression analyzer analyzing the expression by structuring the expression to reflect the sequence of operations.

16. The query representation processing system as claimed in claim 15, wherein the query statement structure analyzer further comprises:
a referenced element analyzer analyzing referenced elements for a component that is based on a reference to another element;

17. The query representation processing system as claimed in claim 11, wherein the query statement structure analyzer comprises:
a table operation analyzer analyzing table operations in SQL statements to identify select blocks and other components of the table operation definition for which further analysis should be made;
a select block analyzer reviewing select statement blocks to understand their semantics and identify components in the select statement blocks on which the analysis should be focused;
an MDX element analyzer analyzing a list of axis, slicer, calculated members and named sets in the MDX statements to identify components for which further analysis should be made;
a component analyzer analyzing the identified components to identify a component that is based on an expression; and
an expression analyzer analyzing the expression by structuring the expression to reflect the sequence of operations;
wherein the query statement structure analyzer uses the table operation analyzer, the select block analyzer, the component analyzer and the expression analyzer to perform the top-down analysis of a SQL statement; and
the query statement structure analyzer uses the MDX element analyzer, the component analyzer and the expression analyzer to perform the top-down analysis of a MDX statement.

18. The query representation processing system as claimed in claim 11, wherein the statement text format manager comprises:
a text structure modifier inserting spaces and line breaks or tags identifying each block beginning and ending in a language string of the statement based on formatting rules to brake the statement into a tree of structural blocks;
a block details handler transitioning the presentation of the tree of structural blocks to more detail presentation; and
a higher level view handler transitioning the detail presentation to a higher level view represented by a tree of logical blocks.

19. The query representation processing system as claimed in claim 11, wherein the logical blocks representation manager shortens the representation based on abbreviation rules.

20. The query representation processing system as claimed in claim 11, further comprising:
a visualization rules manager managing declaration of visualization rules including formatting rules based on which the statement text format manager formats the text of the statement and abbreviation rules based on which the logical blocks representation manager shortens the representation.

21. The query representation processing system as claimed in claim 20, wherein the visualization rules manager comprises:
a user interface allowing management of declaration of the visualization rules; and
a rule store handler coupled with a memory and storing the declaration of the visualization rules, and allowing the use of the visualization rules by the statement text format manager and the logical block representation manager.

22. A computer program product for processing query representation, the computer program product comprising:
a computer usable medium having computer usable program code embodied therewith, the computer usable program code comprising:
computer usable program code configured to perform a method comprising:
receiving a query to analyze, the query containing at least a statement;
analyzing the statement to determine a query structure of elements forming the statement;
formatting text of the statement to reflect the query structure;
replacing the formatted text with an equivalent tree of logical blocs representing the statement in a higher level;
shortening the representation of one or more of the logical blocks; and
generating a data flow tree of macro operation nodes based on the logical blocks for presentation to a user.
